(19) United States
(12) Patent Application Publication
(10) Pub. No.: US 2008/0215893 A1
(43) Pub. Date: Sep. 4, 2008

(54) Multiple levels of guided scrambling

(75) Inventors: William Gene Bliss, Thornton, CO (US); Bahjat Zafer, Cupertino, CA (US)

Correspondence Address: GARLICK HARRISON & MARKISON, P.O. BOX 160727, AUSTIN, TX, 78716-0727, US

(73) Assignee: BROADCOM CORPORATION, Irvine, CA (US)

(21) Appl. No.: 11/965,778

(22) Filed: Dec. 28, 2007

Related U.S. Application Data
(60) Provisional application No. 60/882,964, filed on Dec. 31, 2006.

(51) Int. Cl. H04L 9/00

(52) U.S. Cl. 713/189

(57) ABSTRACT

Multiple levels of guided scrambling. Selective scrambling is performed on user data (or any information) that is to be output. The selection of which scrambling is to be employed can be based on whether or not a baseline error constraint and/or randomness constraint is met. The writing of the scrambled user data can be performed in parallel with, during the same time period, and/or simultaneously with the determination of whether or not a baseline error constraint and/or randomness constraint is met. If the constraint is not met, the outputting and/or writing of the scrambled user data can be aborted mid-process.

### CROSS REFERENCE TO RELATED PATENTS/PATENT APPLICATIONS

### PROVISIONAL PRIORITY CLAIMS

The present U.S. Utility Patent Application claims priority pursuant to 35 U.S.C. §119(e) to the following U.S. Provisional Patent Application which is hereby incorporated herein by reference in its entirety and made part of the present U.S. Utility Patent Application for all purposes:

1. U.S. Provisional Application Ser. No. 60/882,964, entitled “Multiple levels of guided scrambling,” (Attorney Docket No. BP5591), filed Dec. 31, 2006, pending.

### BACKGROUND OF THE INVENTION

1. Technical Field of the Invention

The invention relates generally to hard disk drives (HDDs); and, more particularly, it relates to performing selective scrambling and/or encoding of information to be written to storage media of such HDDs.

2. Description of Related Art

As is known, many varieties of memory storage devices (e.g. hard disk drives (HDDs)), such as magnetic disk drives are used to provide data storage for a host device, either directly, or through a network such as a storage area network (SAN) or network attached storage (NAS). Such a memory storage system (e.g., a HDD) can itself be viewed as a communication system in which information is encoded and provided via a communication channel to a storage media; the reverse direction of communication is also performed in a HDD in which data is read from the media and passed through the communication channel (e.g., sometimes referred to as a read channel in the HDD context) at which point it is decoded to makes estimates of the information that is read.

Typical host devices include stand alone computer systems such as a desktop or laptop computer, enterprise storage devices such as servers, storage arrays such as a redundant array of independent disks (RAID) arrays, storage routers, storage switches and storage directors, and other consumer devices such as video game systems and digital video recorders. These devices provide high storage capacity in a cost effective manner.

Within such memory storage devices, there is sometimes scrambling that is performed on information to be written to the storage media therein. However, the information to be scrambled can be of any of a variety of forms, and sometimes the scrambling that is employed does not provide a sufficiently low degree of baseline error.

### BRIEF SUMMARY OF THE INVENTION

The present invention is directed to apparatus and methods of operation that are further described in the following Brief Description of the Several Views of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWINGS

FIG. 1 illustrates an embodiment of a disk drive unit.

FIG. 2 illustrates an embodiment of an apparatus that includes a disk controller.

FIG. 3A illustrates an embodiment of a handheld audio unit.

FIG. 3B illustrates an embodiment of a computer.

FIG. 3C illustrates an embodiment of a wireless communication device.

FIG. 3D illustrates an embodiment of a personal digital assistant (PDA).

FIG. 3E illustrates an embodiment of a laptop computer.

FIG. 4 illustrates an embodiment of a block diagram of a scrambler wherein the scrambler is operable produce pseudo random data to be written to magnetic media.

FIG. 5 illustrates an embodiment of a block diagram illustrating an embodiment of an encoding and decoding process.

FIG. 6 illustrates an embodiment of an encoding and decoding process.

FIG. 7 illustrates an embodiment of an RDS ENDEC.

FIG. 8 illustrates an embodiment of a high level functional diagram of an embodiment of an encoding process.

FIG. 9 illustrates an embodiment of an embodiment of a high level functional diagram of an encoding process.

FIG. 10 illustrates an embodiment of a logic flow diagram describing the method to write data to a write path within storage media such as a hard disk drive.

FIG. 11 illustrates an embodiment of a block diagram illustrating a guided scrambling encoding and decoding process.

FIG. 12 illustrates an alternative embodiment of guided scrambling encoding and decoding process.

FIG. 13 and FIG. 14 illustrate embodiments of methods for performing selective scrambling of information.

### DETAILED DESCRIPTION OF THE INVENTION

A novel means of performing selective scrambling of user data (or any information) to be written to storage media within a variety of applications including those employing a hard disk drive (HDD). One selected form of scrambling (e.g., using a first set of guide bits) can be performed on the user data to generate first scrambled user data. This first scrambled user data can also subsequently undergo additional encoding as well before being output (e.g., to a communication channel) and then written to the storage media.

In some embodiments, the writing of the first scrambled user data is performed simultaneous with (e.g., in parallel with) determining whether the first scrambled user data meets an acceptable baseline error and/or randomness constraint. If it does not, the writing of the first scrambled user data can be aborted, and then another selected form of scrambling (e.g., using a second set of guide bits) can be performed on the user data to generate second scrambled user data. The writing of the second scrambled user data is performed simultaneous with (e.g., in parallel with) determining whether the second scrambled user data meets the acceptable baseline error and/or randomness constraint. This process can be performed until a sufficiently acceptable baseline error and/or randomness constraint is met with a particular set of guide bits. Alternatively, this process can be performed a predetermined number of times and those guide bits giving the most acceptable baseline error and/or randomness constraint are the ones actually employed which result in an outputting of the scrambled user data without undergoing an abort command. In such an embodiment as presented herein, there is no need to perform buffering of the user data (e.g., buffering of a whole sector of user data), but rather the outputting and/or writing process can begin immediately and then the write process can be interrupted (e.g., aborted) is a desired threshold is not met in terms of an acceptable baseline error and/or randomness constraint. This threshold can be set at a sufficiently low level that the ‘abort rate’ is acceptably low (based on a design constraint) so as not to impact throughput to the storage media (e.g., writing of information thereto). Also, this functionality can be extended to multiple hierarchies as well that may include various levels of encoding therein.

In alternative embodiments, the determination of which guide bits provide a most acceptable baseline error and/or randomness constraint can be performed initially, and then those guide bits giving the most acceptable baseline error and/or randomness constraint are the ones actually employed which result in an outputting of the scrambled user data.

In even other embodiments, multiple versions of scrambled user data (e.g., two or more) can all be calculated in parallel with one another (using two or more sets of guide bits), and the scrambled user data having the most acceptable baseline error and/or randomness constraint is the scrambled user data that is actually employed and results in an outputting of the scrambled user data.

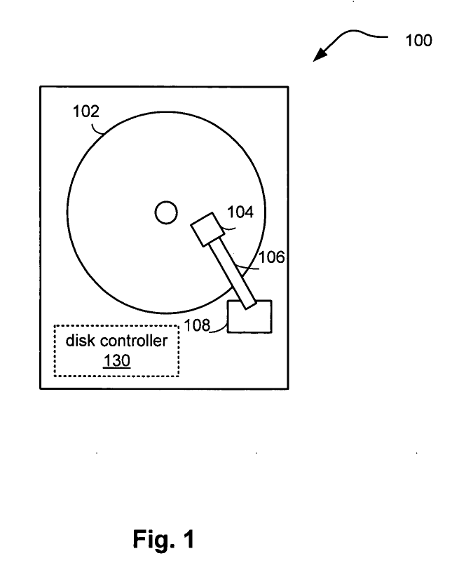

FIG. 1 illustrates an embodiment of a disk drive unit 100. In particular, disk drive unit 100 includes a disk 102 that is rotated by a servo motor (not specifically shown) at a velocity such as 3600 revolutions per minute (RPM), 4200 RPM, 4800 RPM, 5,400 RPM, 7,200 RPM, 10,000 RPM, 15,000 RPM; however, other velocities including greater or lesser velocities may likewise be used, depending on the particular application and implementation in a host device. In one possible embodiment, disk 102 can be a magnetic disk that stores information as magnetic field changes on some type of magnetic medium. The medium can be a rigid or non-rigid, removable or non-removable, that consists of or is coated with magnetic material.

Disk drive unit 100 further includes one or more read/write heads 104 that are coupled to arm 106 that is moved by actuator 108 over the surface of the disk 102 either by translation, rotation or both. A disk controller 130 is included for controlling the read and write operations to and from the drive, for controlling the speed of the servo motor and the motion of actuator 108, and for providing an interface to and from the host device.

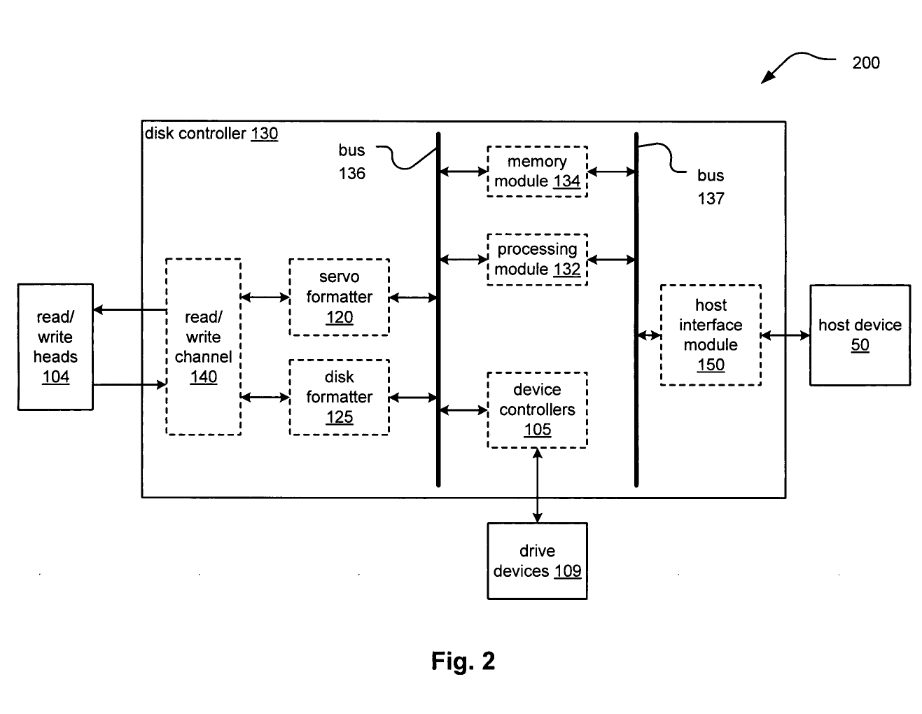

FIG. 2 illustrates an embodiment of an apparatus 200 that includes a disk controller 130. In particular, disk controller 130 includes a read/write channel 140 for reading and writing data to and from disk 102 through read/write heads 104. Disk formatter 125 is included for controlling the formatting of data and provides clock signals and other timing signals that control the flow of the data written to, and data read from disk 102. Servo formatter 120 provides clock signals and other timing signals based on servo control data read from disk 102. Device controllers 105 control the operation of drive devices 109 such as actuator 108 and the servo motor, etc. Host interface 150 receives read and write commands from host device 50 and transmits data read from disk 102 along with other control information in accordance with a host interface protocol. In one embodiment, the host interface protocol can include, SCSI, SATA, enhanced integrated drive electronics (EIDE), or any number of other host interface protocols, either open or proprietary that can be used for this purpose.

Disk controller 130 further includes a processing module 132 and memory module 134. Processing module 132 can be implemented using one or more microprocessors, micro-controllers, digital signal processors, microcomputers, central processing units, field programmable gate arrays, programmable logic devices, state machines, logic circuits, analog circuits, digital circuits, and/or any devices that manipulates signal (analog and/or digital) based on operational instructions that are stored in memory module 134. When processing module 132 is implemented with two or more devices, each device can perform the same steps, processes or functions in order to provide fault tolerance or redundancy. Alternatively, the function, steps and processes performed by processing module 132 can be split between different devices to provide greater computational speed and/or efficiency.

Memory module 134 may be a single memory device or a plurality of memory devices. Such a memory device may be a read-only memory, random access memory, volatile memory, non-volatile memory, static random access memory (SRAM), dynamic random access memory (DRAM), flash memory, cache memory, and/or any device that stores digital information. Note that when the processing module 132 implements one or more of its functions via a state machine, analog circuitry, digital circuitry, and/or logic circuitry, the memory module 134 storing the corresponding operational instructions may be embedded within, or external to, the circuitry comprising the state machine, analog circuitry, digital circuitry, and/or logic circuitry. Further note that, the memory module 134 stores, and the processing module 132 executes, operational instructions that can correspond to one or more of the steps or a process, method and/or function illustrated herein.

Disk controller 130 includes a plurality of modules, in particular, device controllers 105, processing module 132, memory module 134, read/write channel 140, disk formatter 125, and servo formatter 120 that are interconnected via bus 136 and bus 137. The host interface 150 can be connected to only the bus 137 and communicates with the host device 50. Each of these modules can be implemented in hardware, firmware, software or a combination thereof, in accordance with the broad scope of the present invention. While a particular bus architecture is shown in FIG. 2 with buses 136 and 137, alternative bus architectures that include either a single bus configuration or additional data buses, further connectivity, such as direct connectivity between the various modules, are likewise possible to implement the features and functions included in various embodiments.

In one possible embodiment, one or more modules of disk controller 130 are implemented as part of a system on a chip (SoC) integrated circuit. In an embodiment, this SoC integrated circuit includes a digital portion that can include additional modules such as protocol converters, linear block code encoding and decoding modules, etc., and an analog portion that includes device controllers 105 and optionally additional modules, such as a power supply, etc. In a further embodiment, the various functions and features of disk controller 130 are implemented in a plurality of integrated circuit devices that communicate and combine to perform the functionality of disk controller 130.

When the drive unit 100 is manufactured, disk formatter 125 writes a plurality of servo wedges along with a corresponding plurality of servo address marks at equal radial distance along the disk 102. The servo address marks are used by the timing generator for triggering the “start time” for various events employed when accessing the media of the disk 102 through read/write heads 104.

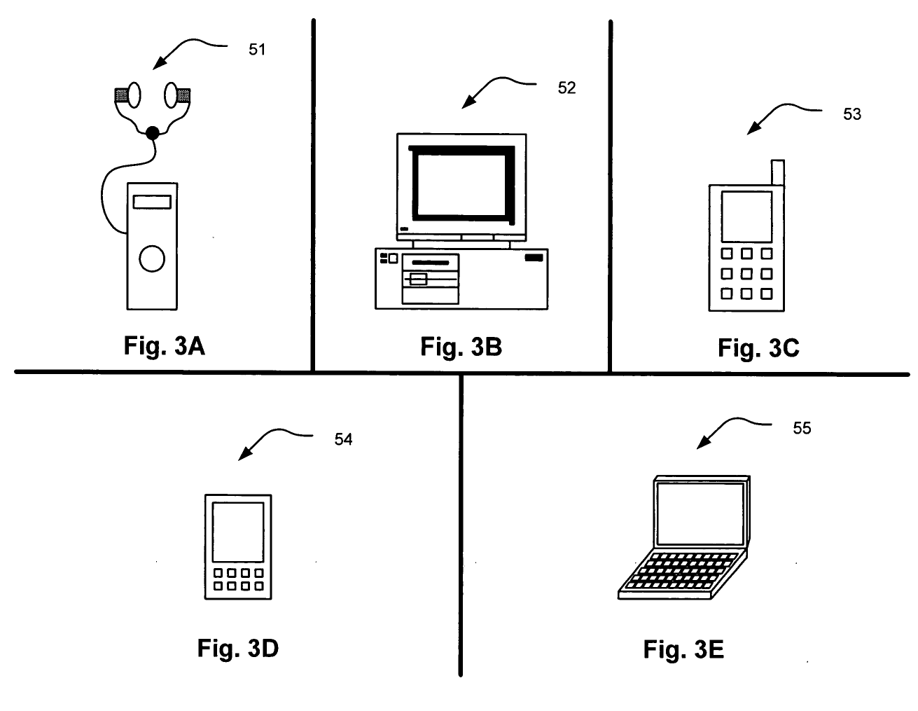

FIG. 3A illustrates an embodiment of a handheld audio unit 51. In particular, disk drive unit 100 can be implemented in the handheld audio unit 51. In one possible embodiment, the disk drive unit 100 can include a small form factor magnetic hard disk whose disk 102 has a diameter 1.8″ or smaller that is incorporated into or otherwise used by handheld audio unit 51 to provide general storage or storage of audio content such as motion picture expert group (MPEG) audio layer 3 (MP3) files or Windows Media Architecture (WMA) files, video content such as MPEG4 files for playback to a user, and/or any other type of information that may be stored in a digital format.

FIG. 3B illustrates an embodiment of a computer 52. In particular, disk drive unit 100 can be implemented in the computer 52. In one possible embodiment, disk drive unit 100 can include a small form factor magnetic hard disk whose disk 102 has a diameter 1.8″ or smaller, a 2.5″ or 3.5″ drive or larger drive for applications such as enterprise storage applications. Disk drive 100 is incorporated into or otherwise used by computer 52 to provide general purpose storage for any type of information in digital format. Computer 52 can be a desktop computer, or an enterprise storage devices such a server, of a host computer that is attached to a storage array such as a redundant array of independent disks (RAID) array, storage router, edge router, storage switch and/or storage director.

FIG. 3C illustrates an embodiment of a wireless communication device 53. In particular, disk drive unit 100 can be implemented in the wireless communication device 53. In one possible embodiment, disk drive unit 100 can include a small form factor magnetic hard disk whose disk 102 has a diameter 1.8″ or smaller that is incorporated into or otherwise used by wireless communication device 53 to provide general storage or storage of audio content such as motion picture expert group (MPEG) audio layer 3 (MP3) files or Windows Media Architecture (WMA) files, video content such as MPEG4 files, JPEG (joint photographic expert group) files, bitmap files and files stored in other graphics formats that may be captured by an integrated camera or downloaded to the wireless communication device 53, emails, webpage information and other information downloaded from the Internet, address book information, and/or any other type of information that may be stored in a digital format.

In a possible embodiment, wireless communication device 53 is capable of communicating via a wireless telephone network such as a cellular, personal communications service (PCS), general packet radio service (GPRS), global system for mobile communications (GSM), and integrated digital enhanced network (iDEN) or other wireless communications network capable of sending and receiving telephone calls. Further, wireless communication device 53 is capable of communicating via the Internet to access email, download content, access websites, and provide steaming audio and/or video programming. In this fashion, wireless communication device 53 can place and receive telephone calls, text messages such as emails, short message service (SMS) messages, pages and other data messages that can include attachments such as documents, audio files, video files, images and other graphics.

FIG. 3D illustrates an embodiment of a personal digital assistant (PDA) 54. In particular, disk drive unit 100 can be implemented in the personal digital assistant (PDA) 54. In one possible embodiment, disk drive unit 100 can include a small form factor magnetic hard disk whose disk 102 has a diameter 1.8″ or smaller that is incorporated into or otherwise used by personal digital assistant 54 to provide general storage or storage of audio content such as motion picture expert group (MPEG) audio layer 3 (MP3) files or Windows Media Architecture (WMA) files, video content such as MPEG4 files, JPEG point photographic expert group) files, bitmap files and files stored in other graphics formats, emails, webpage information and other information downloaded from the Internet, address book information, and/or any other type of information that may be stored in a digital format.

FIG. 3E illustrates an embodiment of a laptop computer 55. In particular, disk drive unit 100 can be implemented in the laptop computer 55. In one possible embodiment, disk drive unit 100 can include a small form factor magnetic hard disk whose disk 102 has a diameter 1.8″ or smaller, or a 2.5″ drive. Disk drive 100 is incorporated into or otherwise used by laptop computer 52 to provide general purpose storage for any type of information in digital format.

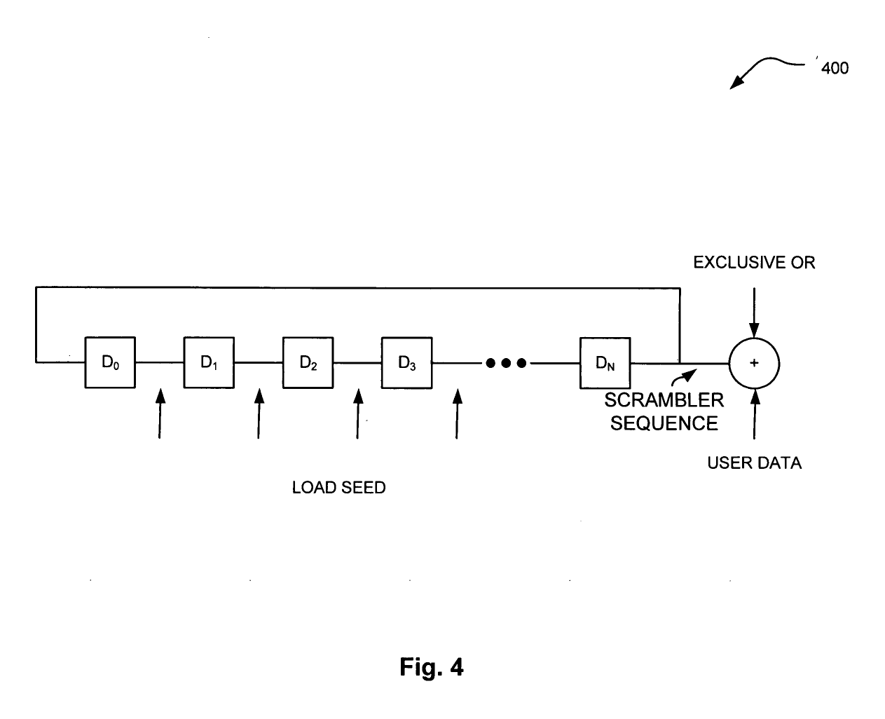

FIG. 4 illustrates an embodiment of a block diagram of a scrambler 400 wherein the scrambler is operable produce pseudo random data to be written to magnetic media. The use of a scrambler can be employed to process non-random data (e.g., user data and/or any other information) in order to produce pseudo random data to be output and/or written to the channel of a HDD that couples to the magnetic storage media of a HDD. This process may reduce or break up undesirably non-randomness within the data and make the written user data appear random. Any baseline error (e.g., DC offset) in the signal eventually to the written to the storage media of the HDD can be minimized (if not eliminated completely).

Scrambler 400 as shown here may be a string of flip flops D_{O} through D_{N} wherein the scrambler's sequence is produced based on a seed loaded into the flip flops D_{O} through D_{N}. This output (e.g., a scrambler sequence) may be exclusive OR'd (XOR-ed) with the user data to produce the pseudo random data to be output and/or written to magnetic media.

The seed may be used to initialize the flip flops. This is generally known mathematically such that if the seed is represented as Sₓ, then the output is depicted as

$${[ \frac{{S}_{x}}{{G}_{x}} ]}_{rem} .$$

When Gₓ is a primitive polynomial of degree N, the output is a repeating sequence having a period of 2^{N}−1.

This produces a pseudo random sequence that would typically not be present in user data, or this can be viewed as ensuring a pseudo random sequence is in fact present in the user data. In certain embodiments this results in a sequence being “perfectly white”. For example, if one were to do a Fourier transform on the sequence this would result in all bins within the Fourier transformer having equal energy. One embodiment employs a value of N that is equal to 12 resulting in a period of 4093 bits. This pseudo random sequence when combined with (e.g., added to) user data results in random looking data that facilitates processing of the data in the read/write channel within a magnetic storage or other like storage device.

Other properties of this process ensure that the seed results in the same scrambler sequence having a relatively long period. Alternative embodiments may also monitor the written data such that if a portion of the written data compares unfavorably with some randomness constraint (e.g., RLL (Run Length Limited) constraint, DC content, etc.), then the write operation may be aborted, and the seed may then be changed. This process can be repeated with a new seed in order to provide sufficiently random data to facilitate channel processing. The threshold by which this randomness constraint and/or baseline error constraint is met can be predetermined, adaptively determined based on some real time conditions and/or system operation parameters, and/or determined using some other means.

To recover the scrambled or pseudo random data, one merely needs to generate the appropriate scramble sequence using the appropriate seed and then exclusively OR the scramble sequence with the scrambled user data to produce unscrambled user data.

Alternative embodiments may also make a decision to abort the write process while monitoring the writing of the data. These decisions may be based on RLL, DC content, or other factors within the data to be written to media. The seed, if the same polynomial is kept, may merely involve shifting the seed. Aborting the writing process should be minimized to an acceptable low rate for the particular application, as this may appear as a glitch within the processing within the hard drive.

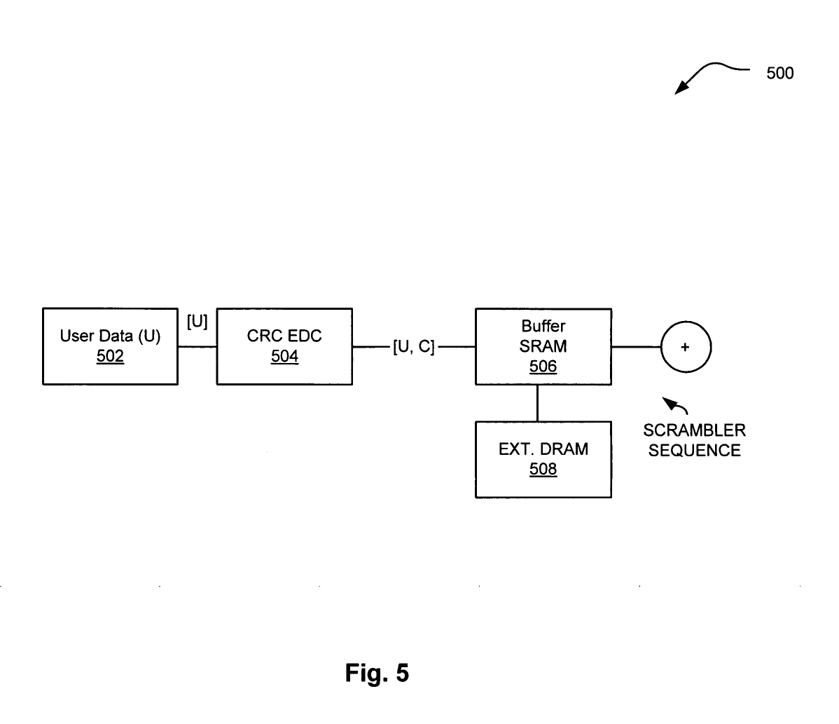

FIG. 5 illustrates an embodiment of a block diagram illustrating an embodiment of an encoding and decoding process 500. Initially, user data is provided in block 502. Error detection and correction (EDC) encoding, as well as cyclic redundancy check (CRC) encoding may be performed on the user data in block 504. This will result in the user data having some redundancy, parity, and/or check information being provided to a buffer, such as SRAM 506 or an external DRAM 508, which may then be processed by the hard drive controller, where it is combined with the scramble code to produce pseudo random scrambled data to be written to media. The pseudo random scrambled data to be written to media may then be monitored for potential abort conditions. If an abort conditions exists a different seed may then be applied to produce a different scramble code, which should result in a different result regarding potential abort conditions.

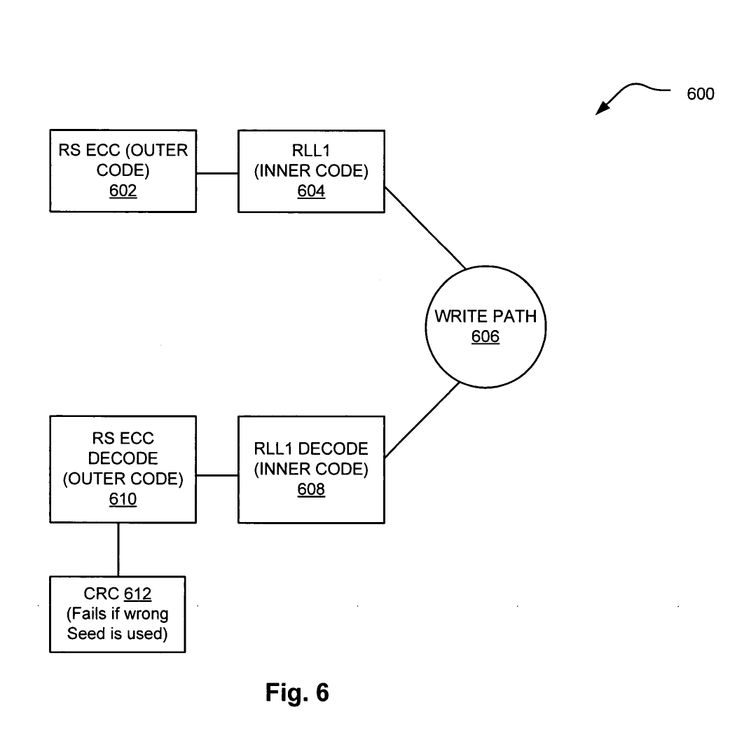

FIG. 6 illustrates an embodiment of an encoding and decoding process 600. In this embodiment, RS (Reed-Solomon) error correction code (ECC) processing or some other form of outer encoding is performed on the information (e.g., user data, which may have already undergone scrambling) in processing block 602. Then inner coding processes may be applied using a guided scrambler in order to ensure a particular RLL constraint is met, a sufficiently acceptable DC content is existent, or otherwise to provide (or ensure) that pseudo random scrambled data is output and may be written to the magnetic media.

Grading of the data produced from one or both of the outer code processing block 602 the inner code processing block 604 may be performed to determine if a write abort should occur as discussed previously. Otherwise the provide pseudo random scrambled data is written to media via the write path 606.

The second half shows the inner code decoding process 608 and outer code decoding process 610 where pseudo random scrambled data is read from the magnetic media via read/write path 606 wherein noise may determine whether or not there is a need for error correction. In processing block 608, RLL1 decode operation (e.g., corresponding to the encoding performed in block 604), such as a scramble decode, may be applied to the data. Then, in process block 610, RS ECC decoding may be performed on the received signal to make estimates of information encoded therein. Cyclical redundancy checking may also be performed within block 612, in which a failure of the CRC could result in an indication that an improper seed was employed.

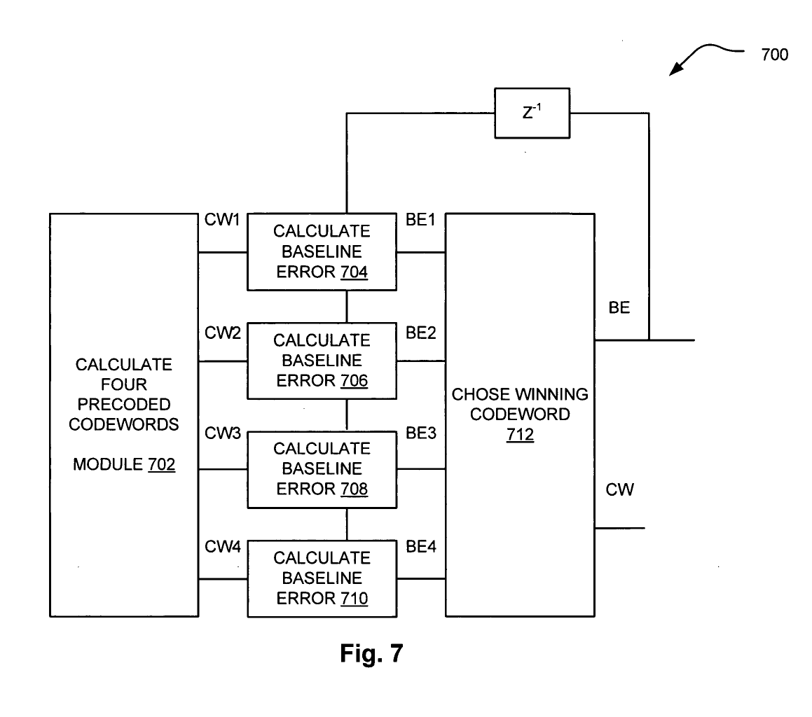

FIG. 7 illustrates an embodiment of an RDS ENDEC 700. Processing module 702 generates a plurality of different scrambler codes (e.g., four in this particular embodiment, though certainly as few as two or more than four could alternatively be generated in other embodiments).

These scrambler codes are then used to generate various versions of scrambled user data (e.g., shown here CW1, CW2, CW3 and CW4, respectively) and baseline error modules 704, 706, 708 and 710 are implemented to determines the baseline error and/or randomness of each of the various version of scrambled user data (e.g., shown as shown here BE1, BE2, BE3 and BE4, respectively). Then, a processing module 712 can be implemented to choose a winning scrambled user data (e.g., winning code word) from the plurality of pre-coded code words (e.g., versions of scrambled user data) based on the associated baseline error and/or randomness.

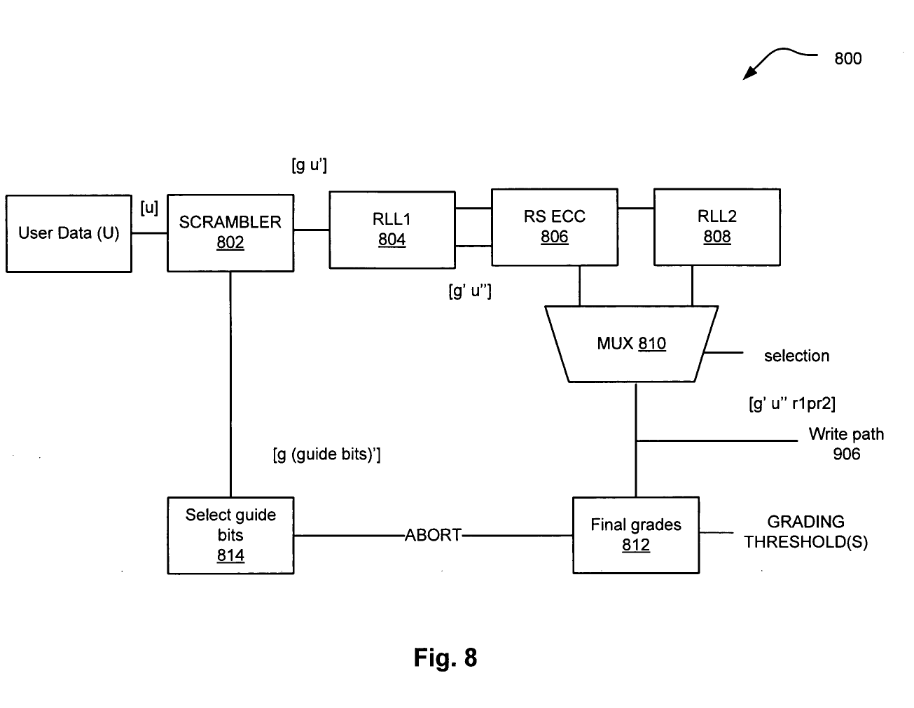

FIG. 8 illustrates an embodiment of a high level functional diagram 800 of an embodiment of an encoding process. User data is received and scrambled using within scrambler 802 which may be implemented using a 12-bit scrambling code word.

Block 804 processes the user data and performs RLL encoding thereon. Block 806 performs RS or ECC error correcting coding and additional RLL encoding may be performed with processing module 808. Multiplexer 810 (having a selection signal provided thereto) provides an output that grading module 812 evaluates against grading thresholds wherein when the grades compare unfavorably with the grading thresholds a firmware write abort may be issued causing a new set of guide bits to be selected for the input to scrambler 802 by processing block 814. In the event that the grades of the pseudo random data outputted by multiplexer 810 compare favorably to the grading thresholds this information may be then provided to the write path for the magnetic storage media.

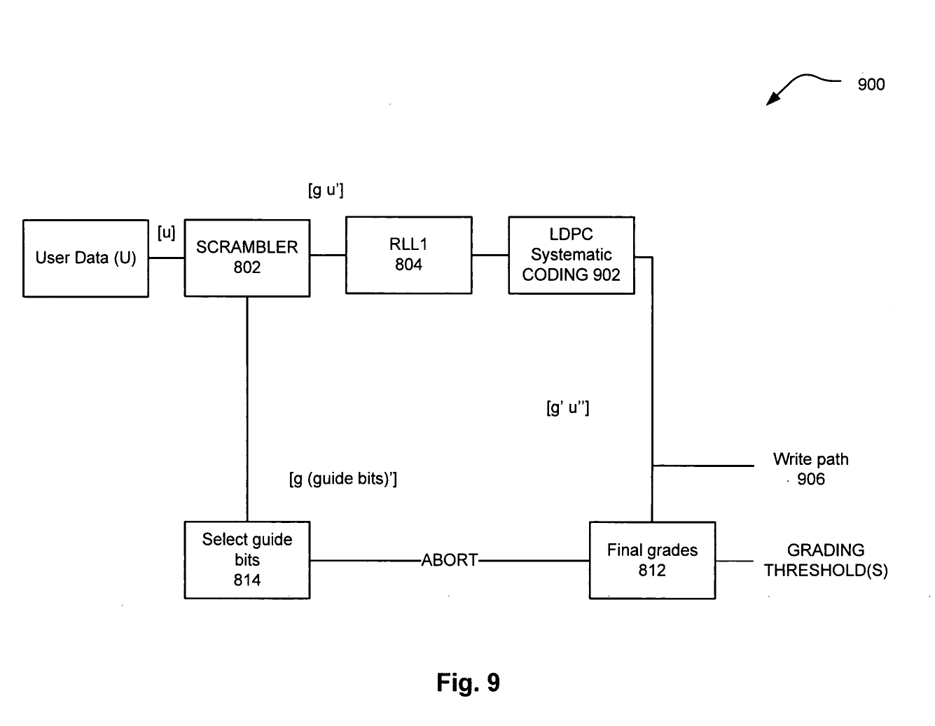

FIG. 9 illustrates an embodiment of an embodiment of a high level functional diagram of an encoding process 900. User data is received and scrambled using within scrambler 802 which may be using for example a 12-bit scrambling code word. Block 804 processes the user data and performs RLL encoding. Block 902 performs LDPC (Low Density Parity Check) systematic coding and provides the output to grading module 812 for evaluation against grading thresholds wherein when the grades compare unfavorably with the grading thresholds a firmware write abort may be issued causing a new set of guide bits to be selected for the input to scrambler 802 by processing block 814. In the event that the grades of the pseudo random data outputted by multiplexer 810 compare favorably to the grading thresholds this information may be then provided to the write path for the magnetic storage media.

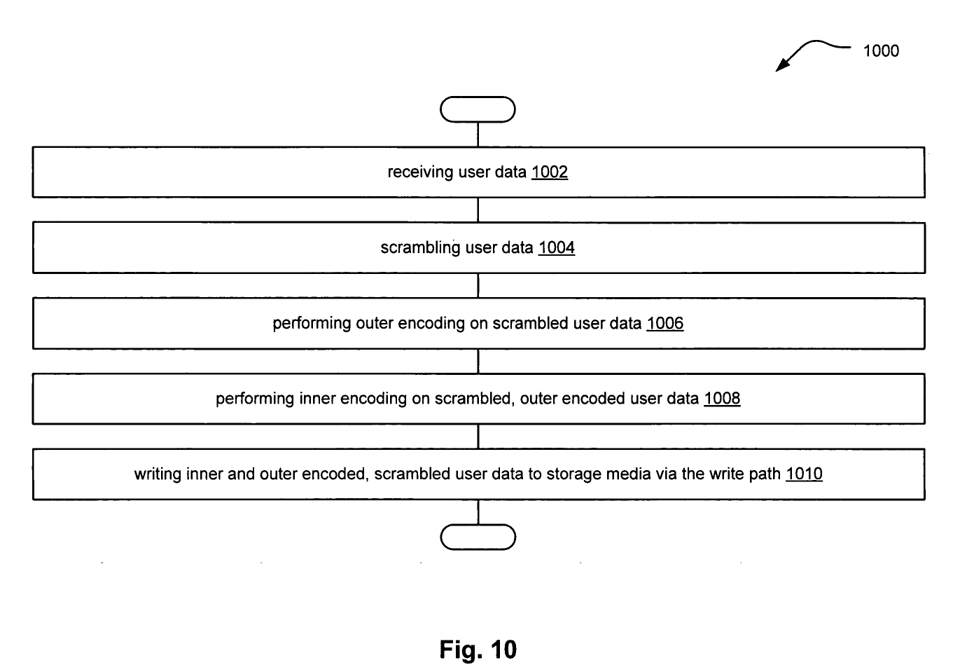

FIG. 10 illustrates an embodiment of a logic flow diagram describing the method 1000 to write data to a write path within storage media such as a hard disk drive. The method 1000 begins by receiving user data as shown in a block 1001. As shown in a block 1004, the method 1000 continues by scrambling the user data using a selected scrambling code to produce scrambled user data.

As shown in a block 1006, the method 1000 continues by performing outer coding on the scrambled user data. This outer coding is followed by inner coding of the scrambled user data as shown in a block 1008. This outer coded and inner coded scrambled user data may be output and/or written to the write path within a HDD as shown in a block 1010.

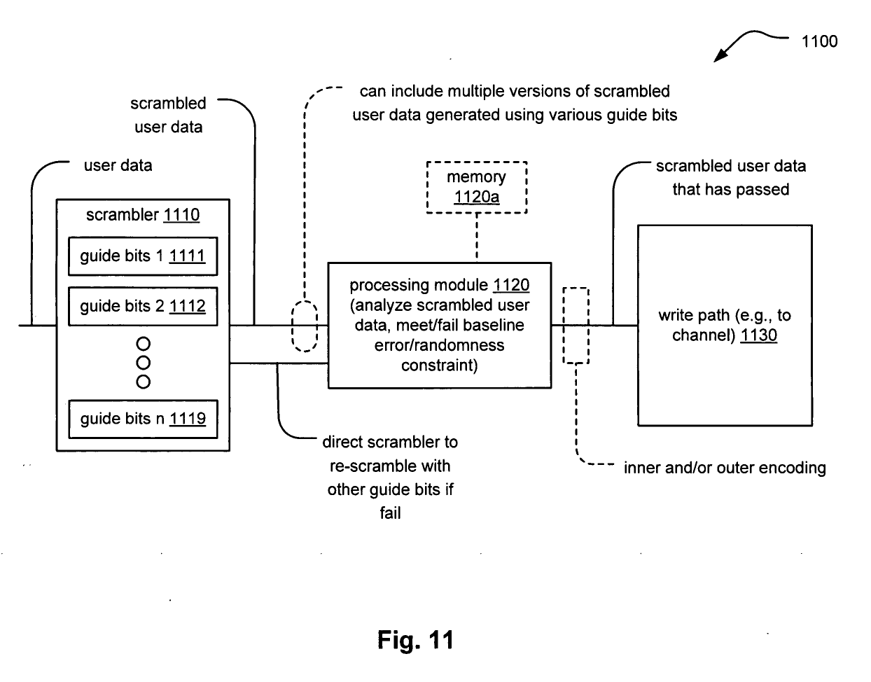

FIG. 11 illustrates an embodiment of a block diagram illustrating a guided scrambling encoding and decoding process 1100. FIG. 11 includes scrambler 1110, processing module 1120, can include memory module 1120a, and write path 1130. Within scrambler 1110 are several sets of guide bits shown as guide bits 1 1111, guide bits 2 1112, . . . , and guide bits n 1119.

As shown in this embodiment, user data is provided to the scrambler 1110, and one or more sets of guides bits are employed to scramble the user data to generate one or more versions of scrambled user data. The scrambled user data may have a pseudo random appearance (when compared to the user date) to improve the characteristics of the data so that it may be written to the magnetic media such as that contained within a HDD.

Processing module 1120 is implemented to analyze the one or more versions of scrambled user data and to determine whether or not it meets an acceptable randomness constraint and/or baseline error. In the event that randomness constraints are not met, the processing module 1120 may direct the scrambler 1110 to re-scramble the user data using another set of guide bits; thereafter, this new (second pass) of one or more versions of scrambled data is provided to processing module 1120. After this processing by processing module 1120 and determination/selection of scrambled user data that has passed the baseline error/randomness constraint, the selected scrambled user data may also undergo inner and/or outer coding before outputting the scrambled user data and writing the data to the write path 1130 (e.g., a channel of a HDD).

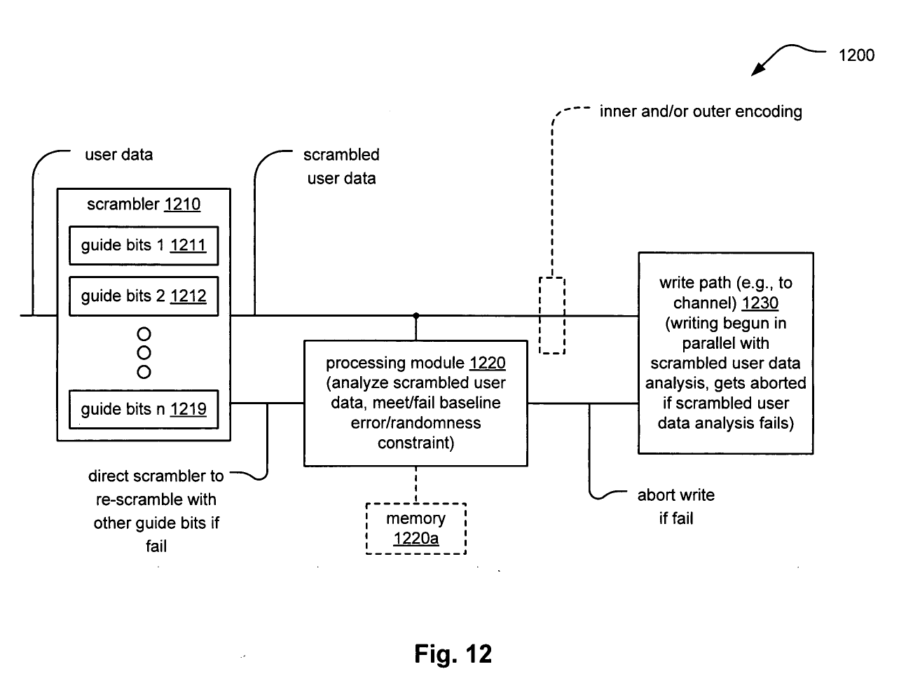

FIG. 12 illustrates an alternative embodiment of guided scrambling encoding and decoding process 1200. This embodiment is somewhat analogous to the previous embodiment with certain differences. FIG. 11 includes scrambler 1210, processing module 1220, can include memory module 1220a, and write path 1230. Within scrambler 1210 are several sets of guide bits shown as guide bits 1 1211, guide bits 2 1212, . . . , and guide bits n 1219.

User data is provided to the scrambler 1110, a selected set of guide bits is employed to scramble the user data to generate scrambled user data. The scrambled user data may have a pseudo random appearance (when compared to the user date) to improve the characteristics of the data so that it may be written to the magnetic media such as that contained within a HDD.

The outputting/writing of the scrambled user data to the write path 1230 is performed in parallel with the processing by the processing module 1120 to analyze the scrambled user data and to determine whether or not it meets an acceptable randomness constraint and/or baseline error.

In the event that randomness constraints are not met, the processing module 1120 may issue an interrupt to abort the write of that particular scrambled user data and also direct the scrambler 1210 to perform scrambling of the user data using another selected set of guide bits. Then, the outputting/writing of this next version of scrambled user data to the write path 1230 is performed in parallel with the processing by the processing module 1120 to analyze this next version of scrambled user data and to determine whether or not it meets an acceptable randomness constraint and/or baseline error. This process can be performed until there is generated scrambled user data that does in fact meet an acceptable randomness constraint and/or baseline error. Alternatively, this processing can be performed a certain number of times, and a most acceptable randomness constraint and/or baseline error corresponding to the various sets of guide bits employed can be the one ultimately employed to scramble the user data before outputting it and/or writing it to the channel of an HDD.

Again, the selected scrambled user data may also undergo inner and/or outer coding before outputting the scrambled user data and writing the data to the write path 1230 (e.g., a channel of a HDD).

It is noted that the various modules (e.g., processing modules, other blocks, etc.) described herein may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The operational instructions may be stored in a memory (e.g., such as memory 1120a or 1220a in the embodiments of FIG. 11 and FIG. 12). The memory may be a single memory device or a plurality of memory devices. Such a memory device may be a read-only memory, random access memory, volatile memory, non-volatile memory, static memory, dynamic memory, flash memory, and/or any device that stores digital information. It is also noted that when the processing module implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. In such an embodiment, a memory stores, and a processing module coupled thereto executes, operational instructions corresponding to at least some of the steps and/or functions illustrated and/or described herein.

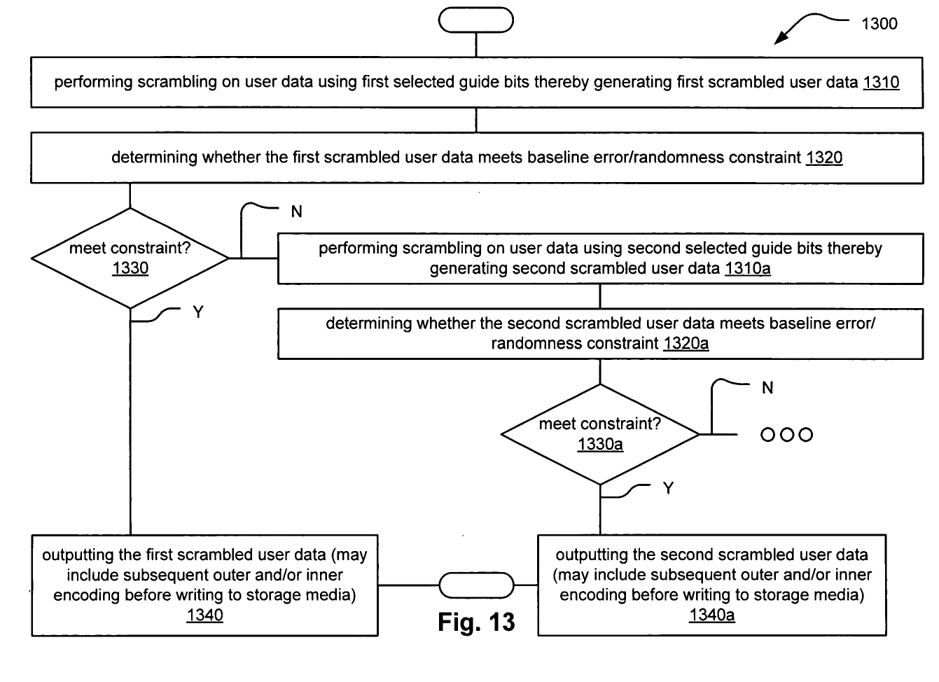

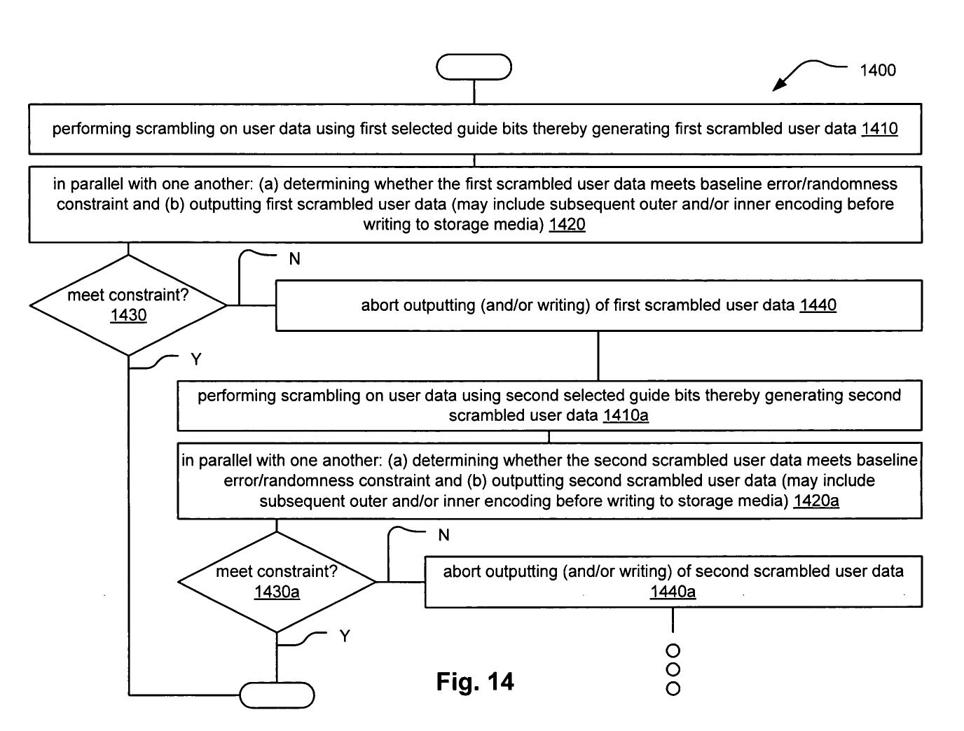

FIG. 13 and FIG. 14 illustrate embodiments of methods for performing selective scrambling of information.

Referring to FIG. 13, the method 1300 begins by performing scrambling on user data using first selected guide bits thereby generating first scrambled user data, as shown in a block 1310. The method 1300 then operates by determining whether the first scrambled user data meets baseline error/randomness constraint, as shown in a block 1320.

Then, in a decision block 1330, it is determined whether or not the baseline error/randomness constraint is met. If it is, then the method 1300 operates by outputting the first scrambled user data, as shown in a block 1340. This may also involve performing subsequent outer and/or inner encoding before writing to storage media.

Alternatively, if it is determined whether or not the baseline error/randomness constraint is met in the decision block 1330, then the method operates by performing scrambling on the user data using second selected guide bits thereby generating second scrambled user data, as shown in a block 1310a. The method 1300 then operates by determining whether the second scrambled user data meets baseline error/randomness constraint, as shown in a block 1320a.

Then, in a decision block 1330a, it is determined whether or not the baseline error/randomness constraint is met. If it is, then the method 1300 operates by outputting the second scrambled user data, as shown in a block 1340a. This may also involve performing subsequent outer and/or inner encoding before writing to storage media.

Alternatively, if it is determined whether or not the baseline error/randomness constraint is met in the decision block 1330a, then the method 1300 can continue by performing scrambling on the user data using third, fourth, etc. selected guide bits thereby generating third, fourth, etc. scrambled user data. The method 1300 can continue to attempt using different sets of guide bits for scrambling until it generates scrambled user data that meets an acceptable randomness constraint and/or baseline error.

Alternatively, this processing can be performed a certain number of times, and a most acceptable randomness constraint and/or baseline error corresponding to the various sets of guide bits employed can be the one ultimately employed to scramble the user data before outputting it and/or writing it to the channel of an HDD.

Referring to FIG. 14, the method 1400 begins by performing scrambling on user data using first selected guide bits thereby generating first scrambled user data, as shown in a block 1410. In a block 1420, the method 1400 then operates by performing two separate operations in parallel with one another (e.g., during the same period of time and/or simultaneously). The method 1400 performs (a) determining whether the first scrambled user data meets baseline error/randomness constraint and (b) outputting first scrambled user data (may include subsequent outer and/or inner encoding before writing to storage media).

Then, in a decision block 1430, it is determined whether or not the baseline error/randomness constraint is met. If it is, then the method 1400 aborts the outputting (and/or writing) of the first scrambled user data, as shown in a block 1440. The method 1400 continues by performing scrambling on user data using second selected guide bits thereby generating second scrambled user data, as shown in a block 1410a. The method 1400 then operates by performing two separate operations in parallel with one another (e.g., during the same period of time and/or simultaneously). In a block 1420a, the method 1400 performs (a) determining whether the second scrambled user data meets baseline error/randomness constraint and (b) outputting second scrambled user data (may include subsequent outer and/or inner encoding before writing to storage media).

Then, in a decision block 1430a, it is determined whether or not the baseline error/randomness constraint is met. If it is, then the method 1400 aborts the outputting (and/or writing) of the second scrambled user data, as shown in a block 1440a.

The method can continue by performing scrambling on the user data using third, fourth, etc. selected guide bits thereby generating third, fourth, etc. scrambled user data. The method 1400 can continue to attempt using different sets of guide bits for scrambling until it generates scrambled user data that meets an acceptable randomness constraint and/or baseline error.

Alternatively, this processing can be performed a certain number of times, and a most acceptable randomness constraint and/or baseline error corresponding to the various sets of guide bits employed can be the one ultimately employed to scramble the user data before outputting it and/or writing it to the channel of an HDD.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. An apparatus, comprising:
a scrambler implemented to scramble user data thereby generating first scrambled data and second scrambled data; and
a processing module implemented to determine whether the first scrambled data meets a baseline error constraint; and wherein:
if the first scrambled data meets the baseline error constraint, the first scrambled data is written to storage media of a hard disk drive (HDD);
if the first scrambled data does not meets the baseline error constraint, the processing module determines whether second scrambled data generated by the scrambler meets the baseline error constraint; and
if the first scrambled data does not meet the baseline error constraint and the second scrambled data meets the baseline error constraint, the second scrambled data is written to the storage media of the HDD.

2. The apparatus of claim 1, wherein:
the scrambler includes a plurality of guide bit sets;
the scrambler employs a first guide bit set of the plurality of guide bit sets to scramble the user data thereby generating the first scrambled data; and
the scrambler employs a second guide bit set of the plurality of guide bit sets to scramble the user data thereby generating the second scrambled data.

3. The apparatus of claim 1, wherein:
the scrambler simultaneously generates the first scrambled data and the second first scrambled data.

4. The apparatus of claim 1, wherein:
writing of the first scrambled data begins while the processing module determines whether the first scrambled data meets the baseline error constraint.

5. The apparatus of claim 1, wherein:
writing of the first scrambled data begins while the processing module determines whether the first scrambled data meets the baseline error constraint; and
if the first scrambled data does not meet the baseline error constraint, the processing module aborts the writing of the first scrambled data.

6. The apparatus of claim 1, wherein:
if the first scrambled data does not meet the baseline error constraint, the processing module directs the scrambler to scramble the user data thereby generating the second scrambled data.

7. The apparatus of claim 1, further comprising:
an encoder implemented to encode the first scrambled data or second scrambled data before it is written to the storage media.

8. The apparatus of claim 1, further comprising:
an LDPC (Low Density Parity Check) encoder implemented to encode the first scrambled data or second scrambled data before it is written to the storage media.

9. The apparatus of claim 1, further comprising:
a RS (Reed-Solomon) encoder implemented to encode the first scrambled data or second scrambled data before it is written to the storage media.

10. The apparatus of claim 1, further comprising:
an outer encoder implemented to encode the first scrambled data or second scrambled data thereby generating outer encoded, first scrambled data or outer encoded, second scrambled data; and
an inner encoder implemented to encode the outer encoded, first scrambled data or the outer encoded, second scrambled data before it is written to the storage media.

11. The apparatus of claim 1, wherein:
the HDD is implemented within a handheld audio unit, a computer, a wireless communication device, or a personal digital assistant.

12. An apparatus, comprising:
a scrambler implemented to scramble user data using a first guide bit set of a plurality of guide bit sets thereby generating first scrambled data;
a processing module implemented to:
determine whether the first scrambled data meets a baseline error constraint;
if the first scrambled data meets the baseline error constraint, output the first scrambled data;
if the first scrambled data does not meets the baseline error constraint, direct the scrambler to scramble the user data thereby generating second scrambled data and determine whether the second scrambled data meets the baseline error constraint; and wherein:
writing of the first scrambled data to storage media of a hard disk drive (HDD) begins while the processing module determines whether the first scrambled data meets the baseline error constraint; and
if the first scrambled data does not meets the baseline error constraint, the processing module aborts the writing of the first scrambled data and begins writing of the second scrambled data to the storage media.

13. The apparatus of claim 12, further comprising:
an encoder implemented to encode the first scrambled data or second scrambled data before it is written to the storage media.

14. The apparatus of claim 12, further comprising:
an LDPC (Low Density Parity Check) encoder or a RS (Reed-Solomon) encoder implemented to encode the first scrambled data or second scrambled data before it is written to the storage media.

15. The apparatus of claim 12, further comprising:
an outer encoder implemented to encode the first scrambled data or second scrambled data thereby generating outer encoded, first scrambled data or outer encoded, second scrambled data; and
an inner encoder implemented to encode the outer encoded, first scrambled data or the outer encoded, second scrambled data before it is written to the storage media.

16. The apparatus of claim 12, wherein:
the HDD is implemented within a handheld audio unit, a computer, a wireless communication device, or a personal digital assistant.

17. A method for selectively scrambling data, the method comprising:
performing scrambling on user data using first selected guide bits thereby generating first scrambled user data;
simultaneously determining whether the first scrambled user data meets a baseline error constraint and beginning to write the first scrambled user data to storage media of a hard disk drive (HDD);
if the first scrambled data does not meets the baseline error constraint, aborting the writing of the first scrambled user data to the storage media and performing scrambling on the user data using second selected guide bits thereby generating second scrambled user data;
simultaneously determining whether the second scrambled user data meets the baseline error constraint and beginning to write the second scrambled user data to the storage media; and
if the second scrambled data does not meets the baseline error constraint, aborting the writing of the second scrambled user data to the storage media and performing scrambling on the user data using third selected guide bits thereby generating third scrambled user data.

18. The method of claim 17, further comprising:
if each of the first scrambled data, the second scrambled data, and the third scrambled data does not meets the baseline error constraint, selecting one of the first scrambled data, the second scrambled data, or the third scrambled data that has a lowest corresponding baseline error and writing that selected scrambled user data to the storage media.

19. The method of claim 17, further comprising:
encoding the first scrambled data or second scrambled data before it is written to the storage media.

20. The method of claim 17, wherein:
the HDD is implemented within a handheld audio unit, a computer, a wireless communication device, or a personal digital assistant.
